(19) United States
(12) Patent Application Publication
(10) Pub. No.: US 2014/0079916 A1
(43) Pub. Date: Mar. 20, 2014

(54) PROCESS FOR THE LAYER-BY-LAYER PRODUCTION OF LOW-WARPAGE THREE-DIMENSIONAL OBJECTS BY MEANS OF COOLING ELEMENTS

(71) Applicants: Maik GREBE, Bochum (DE); Wolfgang Diekmann, Waltrop (DE); Sigrid Hessel-Geldmann, Haltern am See (DE); Juergen Kreutz, Marl (DE)

(72) Inventors: Maik GREBE, Bochum (DE); Wolfgang Diekmann, Waltrop (DE); Sigrid Hessel-Geldmann, Haltern am See (DE); Juergen Kreutz, Marl (DE)

(73) Assignee: Evonik Industries AG, Essen (DE)

(21) Appl. No.: 14/029,153

(22) Filed: Sep. 17, 2013

(30) Foreign Application Priority Data
Sep. 17, 2012 (DE) 102012216515.0

(51) Int. Cl. B29C 67/00

(52) U.S. Cl. CPC B29C 67/0077
USPC 428/172; 425/174.4; 264/497

(57) ABSTRACT

An apparatus for the simultaneous layer-by-layer production of three-dimensional objects, containing a construction chamber with a height-adjustable construction platform, an apparatus for applying, to the construction platform, a layer of a material that can be hardened by exposure to electromagnetic radiation, and irradiation equipment. The irradiation equipment contains a radiation source emitting electromagnetic radiation, a control unit and a lens located in a beam path of the electromagnetic radiation, for irradiating sites within the layer that correspond to an object, in which a cooling element can be produced at the same time as the object. A process for the layer-by-layer production of a three-dimensional object in the apparatus, involves producing an object and a cooling element at the same time.

### CROSS REFERENCE TO RELATED APPLICATION(S)

This application claims priority to European Application No. 102012216515.0, filed on Sep. 17, 2012, the disclosure of which is incorporated herein by reference in its entirety.

### BACKGROUND OF THE INVENTION

1. Field of the Invention

The present invention relates to an apparatus for the layer-by-layer production of three-dimensional objects, to layer-by-layer production processes, and also to corresponding mouldings.

2. Description of the Background

The rapid provision of prototypes is a task frequently encountered in recent times. Processes permitting this are termed rapid prototyping, rapid manufacturing or else additive fabrication processes. Particularly suitable processes are those whose operation is based on pulverulent materials and in which the desired structures are produced layer-by-layer through selective melting and hardening. Supportive structures for overhangs and undercuts can be omitted here, since the construction-field plane that surrounds the molten regions provides adequate support. The subsequent operation of removal of supports is also omitted. The processes are also suitable for short-run production. The temperature of the construction chamber is selected in such a way that the structures produced layer-by-layer do not warp during the construction process.

A process which has particularly good suitability for the purposes of rapid prototyping is selective laser sintering (SLS). In this process, plastics powders in a chamber are briefly irradiated selectively by light from a laser beam, and the powder particles exposed to the laser beam thus melt. The molten particles coalesce and rapidly solidify again to give a solid mass. Three-dimensional bodies can be produced simply and rapidly by this process, through repeated irradiation of a succession of freshly applied layers.

The process of laser sintering (rapid prototyping) to produce mouldings from pulverulent polymers is described in detail in the Patents U.S. Pat. No. 6,136,948 and WO 96/06881 (both from DTM Corporation). A wide variety of polymers and copolymers is claimed for this application, examples being polyacetate, polypropylene, polyethylene, ionomers and polyamide.

Other processes having good suitability are the SIV (Selective Inhibition of Bonding) process as described in WO 01/38061, and a process as described in EP 1015214. Both processes use infrared heating of a relatively large area in order to melt the powder. The selectivity of melting is achieved in the former process by applying an inhibitor, and in the second process it is achieved by using a mask. US 2004/232583 A1 describes another process. In this, the energy required for fusion is introduced by using a microwave generator, while the selectivity is achieved by applying a susceptor. The document WO 2005/105412 describes a process in which the energy required for fusion is introduced through electromagnetic radiation, while again the selectivity is likewise achieved by applying an absorber.

A problem with the conventionally known processes is non-uniform cooling of the components located in the powder cake. Cooling of the centre of the powder cake naturally occurs significantly later than cooling of the external region (edges). This effect is further amplified by the poor thermal conductivity of the bed of polymer powder present. The large temperature differences within the powder cake lead to warpage of the components. By virtue of the slow cooling of the centre of a powder cake, the powder in the centre of the powder cake is moreover subject to severe thermal stress. In order to minimize the warpage of the components produced layer-by-layer, the prior art cools the powder cake as slowly as possible. This is achieved through insulation or an additional heating system installed around the construction container. Another embodiment according to conventionally known processes cools the construction container in an appropriately temperature-controlled chamber. Warpage of the components is thus reduced, but equally the cooling time is significantly increased, as also therefore is the thermal stress to which the polymer powder is exposed.

DE 102007009273 describes how the powder cake can be cooled. The cooling is achieved by passing a fluid through at least part of the layer-cake. Core zones and edge zones are cooled here. The simultaneous, undifferentiated passage of the fluid through core zones and edge zones cools the edge zones first, and warpage can therefore occur in the object requiring production. Complicated control electronics are required for the procedure. Contamination of the powder cake and of the object requiring production can moreover occur.

It is therefore an object of the present invention to minimize the warpage of components by cooling the powder cake uniformly and/or in a defined manner. The cooling is intended to take place uniformly not only in the external region but also in the centre of the powder cake. Another intention here is to reduce the cooling time and the thermal stress to which the polymer powder is exposed. The intention is, as far as possible, to achieve this without contamination of the powder cake by a fluid and without complicated technology for control for regulation.

### BRIEF DESCRIPTION OF THE DRAWING

The FIGURE shows a schematic diagram of the components of an apparatus according to one embodiment of the invention.

### DETAILED DESCRIPTION OF THE PREFERRED EMBODIMENTS

Apparatuses according to the present invention achieve the object mentioned. The present invention firstly provides an apparatus (1) for the layer-by-layer production of three-dimensional objects comprising a construction chamber (20) with a height-adjustable construction platform (16), and with an apparatus (17) for applying, to the construction platform (16), a layer of a material that can be hardened by exposure to electromagnetic radiation, and with irradiation equipment which comprises a radiation source (11) emitting electromagnetic radiation, a control unit (13) and a lens (18) located in the beam path of the electromagnetic radiation, for irradiating sites within the layer that correspond to the at least one object (15). In the apparatus (1) it is possible to produce at least one cooling element (21) at the same time as the object (15) requiring production. The cooling element (21) preferably comprises a coolant. In one preferred embodiment, the cooling element (21) is integrated into the powder cake (23).

The cooling element (21) and the object (15) are two objects that are separable or separate from one another.

The claimed apparatus (1) brings about defined cooling of the object (15).

Surprisingly, it has been found that apparatuses (1) according to the present invention can achieve uniform cooling of edge zone and core zone of the powder cake after production of the object (15) and of the cooling element (21), without contamination of the powder cake by a fluid and any requirement for complicated technology for control and for regulation.

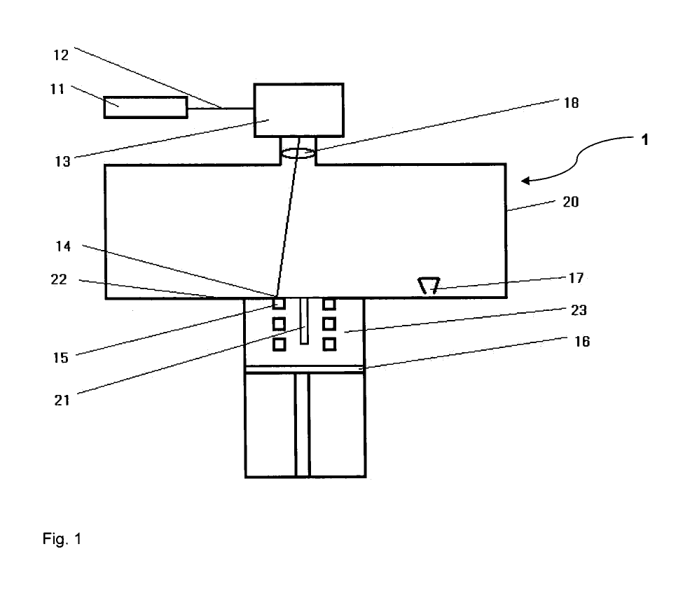

FIG. 1 shows the principles of construction of an apparatus (1) for producing three-dimensional objects according to the present invention. The component is by way of example positioned centrally in the construction field. The laser beam (12) from a laser (11) is deflected by means of a scanning system (13) through the lens (18) onto a temperature-controlled and inertized, preferably nitrogen-inertized, powder surface (14) of the object (15) to be formed. The lens here has the task of separating the remainder of the optical components, e.g. the mirrors of the scanner, from the construction-chamber atmosphere. The lens is often designed as F-theta lens system in order to ensure maximum homogeneity of focus over the entire field of operation. Within the construction chamber, there is the applicator (17) for applying, to the construction platform (16), the material to be hardened. The cooling element (21) has been integrated within the powder cake and serves for defined cooling of the powder cake. The cooling element (21) is preferably composed of a hollow body which preferably has a ratio of wall thickness to cross section smaller than 0.3. The distance between the position of the at least one cooling element (21) and the object (15) is preferably from 5 to 100 mm, with preference from 10 to 50 mm. The cooling element (21) is constructed by means of the layer-by-layer process and is composed of molten or sintered polymer powder. By way of the geometry of the cooling body it is possible to adjust the cooling rate at the appropriate sites within the powder cake.

The cooling body can have a very wide variety of shapes. By way of example, the shape of the cooling body is circular-cylindrical or other cylindrical, toroidal, pyramidal, conical, spherical, cuboidal or cubic, or the cooling body is a knotted object. In one embodiment, the cylinder widens towards one end or towards both ends in the manner of a funnel. The intention here is, given (almost) vertical positioning, to increase physical stability or to facilitate charging of the coolant. It is preferable that the cooling body has been sealed at the underside in such a way that it can receive by way of example a liquid coolant. The cooling body could have been sealed to some extent or completely or can have at least one inlet into which the cooling liquid can be charged. It is preferable that the cooling body has at least one inlet and at least one outlet, in order to permit closed-circuit circulation of the coolant. At the inlets-and outlets there can be hoses provided for the transport of the coolant.

The present invention also provides processes for the layer-by-layer production of three-dimensional objects, where the process comprises the following steps:

The at least one object (15) and the at least one cooling body (21) are first produced at the same time by hardening of polymer powder. During or after conclusion of the construction procedure, a coolant is then charged to the cooling body, and the cooling body here cools the surrounding regions of the powder cake. In one preferred embodiment, the powder is by way of example removed by suction from the internal region of the cooling body before a coolant is charged to the cooling body. The introduction of the coolant into the cooling body avoids coolant-contamination of the powder of the powder cake outside of the cooling body. The coolant can be charged once to the cooling body and can remain there, or can be renewed continuously or regularly. In an alternative possibility, the coolant is used in a closed circuit and is cooled externally (outside of the cooling body). It is also possible to combine the possibilities with one another.

The design, positioning and orientation of the cooling body/bodies can be such that the resultant cooling rate leads to the desired temperature distribution during the cooling procedure within the powder cake. The design of the cooling body/bodies can be such that one or a plurality of inlets and/or outlets is/are present in order to optimize the cooling rate. The coolant can be composed of gaseous, liquid and solid substances or of mixtures of these substances, preference being given here to substances that are unreactive, and in particular inert. Preference is given to gaseous and/or liquid coolants. Examples of those suitable are air, nitrogen, argon, water or water mixtures, high-boiling-point organic solvents, oils or metals such as copper or a steel. The water mixtures can comprise surfactants. Suitable oils are silicone oils. High-boiling-point organic solvents have a boiling point above 100° C. The boiling point is preferably higher than 150° C., particularly preferably higher than 200° C. and very particularly preferably higher than 250° C. Dibenzyltoluene is suitable by way of example, and is obtainable with trade name Marlotherm SH from Sasol Germany GmbH.

The selection of the temperature of the coolant and of the intrinsic properties of the coolant is to be such that the desired temperature distribution is achieved during the cooling procedure within the powder cake. The coolant here can extract the heat by means of thermal conduction, convection, thermal radiation or else evaporative cooling.

The cooling procedure can take place inside of, and outside of, the apparatus (1). It is also possible to carry out the cooling procedure in a temperature-controlled external chamber.

The layer-by-layer production of three-dimensional objects is described below, without any intention that the invention be restricted thereto.

In principle, all of the polymer powders known to the person skilled in the art are suitable for use in the claimed apparatus (1) or in the claimed process. In particular, thermoplastics and thermoelastic materials are suitable, examples being polyethylene (PE, HDPE, LDPE), polypropylene (PP), polyamides, polyesters, polyester esters, polyether esters, polyphenylene ethers, polyacetals, polyalkylene terephthalates, in particular polyethylene terephthalate (PET) and polybutylene terephthalate (PBT), polymethyl methacrylate (PMMA), polyvinyl acetal, polyvinyl chloride (PVC), polyphenylene oxide (PPO), polyoxymethylene (POM), polystyrene (PS), acrylonitrile-butadiene-styrene (ABS), polycarbonates (PC), polyether sulphones, thermoplastic polyurethanes (TPU), polyaryl ether ketones, in particular polyether ether ketone (PEEK), polyether ketone ketone (PEKK), polyether ketone (PEK), polyether ether ketone ketone (PEEKK), polyaryl ether ether ether ketone (PEEEK) or polyether ketone ether ketone ketone (PEKEKK), polyetherimides (PEI), polyarylene sulphides, in particular polyphenylene sulphide (PPS), thermoplastic polyimides (PI), polyamideimides (PAI), polyvinylidene fluorides, and also copolymers of these thermoplastics, e.g. a polyaryl ether ketone (PAEK)/polyaryl ether sulphone (PAES) copolymer, mixtures and/or polymer blends. It is particularly preferable that the polymer powder comprises at least one polyamide or polyether ketones, in particular nylon-P12, nylon-P6, nylon-P6,6 or PEEK, where the polyamides mentioned are particularly preferred.

In a general method of operation, data concerning the shape of the object (15) requiring production is first generated or stored in a computer on the basis of a design program or the like. The processing of the said data for producing the object (15) involves dissecting the object (15) into a large number of horizontal layers which are thin in comparison with the size of the object (15), and providing the geometric data by way of example in the form of data sets, e.g. CAD data, for each of the said layers. This data for each layer can be generated and processed prior to production or simultaneously with production of each layer.

The construction platform (16) is then firstly moved by means of the height-adjustment apparatus to the highest position, in which the surface of the construction platform (16) is in the same plane as the surface of the construction chamber, and it is then lowered by an amount corresponding to the intended thickness of the first layer of material, in such a way as to form, within the resultant recess, a depressed region delimited laterally by the walls of the recess and underneath by the surface of the construction platform (16). A first layer of the material to be solidified, with the intended layer thickness (single layer thickness), is then introduced by way of example by means of an applicator (17) in the shape of a rotating cylinder into the cavity formed by the recess and by the construction platform (16), or into the depressed region, and a heating system is optionally used to heat the sample to a suitable operating temperature, for example from 100° C. to 360° C., preferably from 120° C. to 200° C. Heating systems of this type are familiar to a person skilled in the art. The control unit (13) then controls the deflector equipment in such a way that the deflected light beam (12) successively encounters all of the positions within the layer and sinters or melts the material there. A firm initial base layer can thus be formed. In a second step, the construction platform (16) is lowered by means of the height-adjustment apparatus by an amount usually corresponding to one layer thickness, and a second layer of material is introduced by means of the applicator (17) into the resultant depressed region within the recess, and the heating system is in turn optionally used to heat that layer.

In one embodiment, the deflector equipment can now be controlled by the control unit (13) in such a way that the deflected light beam (12) encounters only that region of the layer of material that is adjacent to the internal surface of the recess, and solidifies the layer of material there by sintering, thus producing a first annular wall layer with a wall thickness of about 2 to 10 mm which completely surrounds the remaining pulverulent material of the layer. This portion of the control system therefore provides an equipment for producing, simultaneously with formation of the object (15) in each layer, a container wall surrounding the object (15) to be formed.

After the construction platform (16) has been lowered by an amount corresponding to the (for example single) layer thickness of the next layer, and the material has been applied and heated in the same way as above, the production of the object (15) and of the cooling element (21) itself can now begin. For this, the control unit (13) controls the deflector equipment in such a way that the deflected light beam (12) encounters those positions of the layer which are to be solidified in accordance with the coordinates stored in the control unit for the object (15) requiring production and for the cooling element (21). The procedure for the remaining layers is analogous. In cases where it is desirable to produce an annular wall region in the form of a vessel wall which encloses the object (15) together with the remaining, unsintered material, and thus prevents escape of the material when the construction platform (16) is lowered below the base of the construction chamber, the equipment sinters an annular wall layer onto the annular wall layer thereunder, for each layer of the object (15). Production of the wall can be omitted if a replaceable vessel corresponding to EP 1037739, or a fixedly incorporated vessel, is used. After cooling, the resulting object (15) can be removed from the apparatus (1). Suitable thermometers measuring by means of contact or measuring without contact can be used for temperature measurement within the resultant object (15) or at its surface.

The present invention also provides the objects (15) produced by the claimed process.

It is assumed that even in the absence of further details it is possible for a person skilled in the art to utilize the above description to the fullest possible extent. The preferred embodiments and examples are therefore to be interpreted simply as descriptive disclosure, and certainly not as disclosure which is in any way limiting.

Examples are used below for further explanation of the present invention. Alternative embodiments of the present invention can be obtained analogously.

### EXAMPLES

Unless otherwise stated, operations in the examples are in accordance with the description below. The experiments were carried out in an EOSINT P380 apparatus from EOS GmbH, Germany. The layer thickness was 0.15 mm. The construction platform was lowered by mm, and 3 mm of powder were applied. The construction chamber was heated to the process temperature within 120 min. The temperature distribution within the construction chamber was not always homogeneous, and the temperature measured by means of the pyrometer incorporated into the apparatus was therefore defined as the construction chamber/process temperature. The process temperature was 175° C., and the removal-chamber temperature was 130° C. Prior to the first irradiation, 80 layers of powder were applied. The laser beam (12) from a laser (11) was deflected by means of a scanning system (13) through the lens (18) onto the temperature-controlled and inertized (N₂) construction-field plane (14). The lens was designed as F-theta lens system, in order to ensure maximum homogeneity of focus across the entire construction-field plane.

A total of 12 objects were constructed, and in each case a group of 4 objects was positioned on one level. The distance between the individual objects of a group was 100 mm. All of the objects of a group were at the same distance from the centre of the construction field. The distance between the levels of the groups was in each case 50 mm. The mouldings involved cubes with edge length in each case 50 mm. Once the irradiation was concluded, 100 further layers were applied before the heating elements in the construction chamber and removal chamber were switched off and the cooling phase was begun. The time needed for each layer during the entire construction process was below 55 s.

In the cooling phase, a PT 100 temperature sensor from Newport Electronics GmbH, Germany was inserted from above to a depth of 140 mm into the powder cake in the centre and at the corners of the construction field (distance from the adjacent edges of the construction field being 30 mm), in order to measure the temperature prevailing at those locations.

### Example 1 (Not According to the Invention)

A PA12 powder having the powder properties in Table 1 was processed. The irradiation parameters were: laser power 19.0 W, scan velocity 1100 mm/s, distance between irradiation lines 0.3 mm. The powder cake was cooled within the machine. Table 2 shows temperatures as a function of time after the end of the construction process.

### Example 2 (According to the Invention)

A PA12 powder having the powder properties in Table 1 was processed. The irradiation parameters were: laser power 19.0 W, scan velocity 1100 mm/s, distance between irradiation lines 0.3 mm. A cooling element was constructed concomitantly in addition to the 12 objects. The cooling element involved a hollow cylinder with external diameter 14 mm, wall thickness 1 mm and height 150 mm. The cylinder was positioned at some distance from the centre of the construction field (the distance between the central axis of the hollow cylinder and the centrepoint of the construction field being 30 mm). Once the construction process had ended, the powder was removed from the interior of the cylinder. The cooling cylinder was flushed with temperature-controlled air (23° C.) at a volume flow rate of 7 l/min. The powder cake was cooled within the machine. Table 2 shows temperatures as a function of time after the end of the construction process.

### Example 3 (According to the Invention)

A PA12 powder having the powder properties in Table 1 was processed. The irradiation parameters were: laser power 19.0 W, scan velocity 1100 mm/s, distance between irradiation lines 0.3 mm. A cooling element was constructed concomitantly in addition to the 12 objects. The cooling element involved a hollow cylinder with external diameter 16 mm, wall thickness 1 mm and height 150 mm, where the lower end of the hollow cylinder had been closed. The upper end of the hollow cylinder had been designed in the shape of a funnel (funnel diameter 25 mm, funnel height 30 mm). The cooling element was positioned at some distance from the centre of the construction field (the distance between the central axis of the hollow cylinder and the centrepoint of the construction field being 20 mm). Once the construction process had ended, the powder was removed from the interior of the cylinder. The cylinder was completely filled with Marlotherm SH (23° C.). The powder cake was cooled within the machine. Table 2 shows temperatures as a function of the time after the end of the construction process.

In Example 1 not according to the invention, it can be seen that the centre of the powder cake cools significantly more slowly than the edges. In the examples according to the invention, the difference between the temperatures at the edge and in the centre is significantly smaller, and the powder cake therefore cools more uniformly. Warpage of the three-dimensional objects requiring production is thus reduced, and the overall effect includes the possibility of removing the three-dimensional objects from the system at an earlier stage.

TABLE 1
Powder properties

| | | | Type of test/test equipment/test |
|---|---|---|---|
| | Value | Unit | parameters |
| Polymer | Nylon-12 | | |
| Bulk density | 0.456 | g/cm³ | DIN EN ISO 60 |
| d50 grain size | 56 | μm | Malvern Mastersizer 2000, dry |
| | | | measurement, 20-40 g of powder metered |
| | | | by means of Scirocco dry dispersion |
| | | | equipment. Feed rate of vibratory chute |
| | | | 70%, dispersion air pressure 3 bar. |
| | | | Specimen measurement time 5 seconds |
| | | | (5000 individual measurements), refractive |
| | | | index and blue-light value defined as 1.52. |
| | | | Evaluation by way of Mie theory. |
| d10 grain size | 41 | μm | Malvern Mastersizer 2000, parameters see |
| | | | d50 grain size |
| d90 grain size | 78 | μm | Malvern Mastersizer 2000, parameters see |
| | | | d50 grain size |
| <10.48 μm | 1.8 | % | Malvern Mastersizer 2000, parameters see |
| | | | d50 grain size |
| Pourability | 27 | s | DIN EN ISO 6186, method A, nozzle outlet |
| | | | diameter 15 mm |
| Solution viscosity | 1.61 | — | ISO 307, Schott AVS Pro, solvent acidic m- |
| | | | cresol, volumetric method, two |
| | | | measurements, dissolution temperature |
| | | | 100° C., dissolution time 2 h, polymer |
| | | | concentration 5 g/l, |
| | | | measurement temperature 25° C. |
| BET (spec. surface area) | 7.2 | m²/g | ISO 9277, Micromeritics TriStar 3000, |
| | | | nitrogen gas adsorption, discontinuous |
| | | | volumetric method, 7 measurement points |
| | | | at relative pressures P/P0 from about 0.05 |
| | | | to about 0.20, dead volume calibration by |
| | | | means of He (99.996%), specimen |
| | | | preparation 1 h at 23° C. + 16 h at 80° C. in |
| | | | vacuo, spec. surface area based on |
| | | | devolatilised specimen, evaluation by |
| | | | means of multipoint determination |
| melting point, 1st heating | 186 | ° C. | DIN 53765 DSC 7 from Perkin Elmer, |
| procedure | | | heating/cooling rate 20 K/min |
| Recrystallisation temperature | 139 | ° C. | DIN 53765 DSC 7 from Perkin Elmer, |
| | | | heating/cooling rate 20 K/min |

| | |
|---|---|
| Conditioning of material | Material is aged for 24 h at 23° C. and 50% humidity prior to processing |

TABLE 2
Temperature [° C.] as a function of measurement position and cooling time

| | Cooling time | | | | | | | | | |
|---|---|---|---|---|---|---|---|---|---|---|
| | 0.1 h | | 1 h | | 5 h | | 10 h | | 20 h | |
| Measurement position | Centre | Edge | Centre | Edge | Centre | Edge | Centre | Edge | Centre | Edge |
| Example 1 | 169 | 146 | 166 | 136 | 162 | 99 | 154 | 74 | 125 | 39 |
| Example 2 | 166 | 145 | 158 | 137 | 149 | 99 | 135 | 74 | 76 | 38 |
| Example 3 | 167 | 146 | 163 | 137 | 148 | 98 | 136 | 74 | 78 | 37 |

1. An apparatus comprising a construction chamber comprising:
a height-adjustable construction platform;
an apparatus for applying, to the construction platform, a layer of a material that can be hardened by exposure to electromagnetic radiation; and
irradiation equipment which comprises a radiation source emitting electromagnetic radiation, a control unit and a lens located in a beam path of the electromagnetic radiation, for irradiating sites within the layer that correspond to an object,
wherein a cooling element can be produced at the same time as the object.

2. The apparatus according to claim 1, wherein the cooling element is integrated into a powder cake.

3. The apparatus according to claim 1, wherein the cooling element is a hollow body.

4. The apparatus according to claim 1, wherein the cooling element comprises a coolant.

5. The apparatus according to claim 4, wherein the coolant is solid, liquid or gaseous.

6. The apparatus according to claim 4, wherein a distance between the cooling element and the object is from 5 to 100 mm.

7. The apparatus according to claim 1, wherein the cooling element has been sealed.

8. The apparatus according to claim 1, wherein the cooling element has an inlet into which a cooling liquid can be charged.

9. The apparatus according to claim 1, wherein a shape of the cooling element is circular-cylindrical or other cylindrical, toroidal, pyramidal, conical, spherical, cuboidal or cubic, or the cooling element is a knotted object.

10. A process for the layer-by-layer production of a three-dimensional object in the apparatus according to claim 1, the process comprising producing an object and a cooling element at the same time.

11. The process according to claim 10, further comprising, after concluding the production, removing the unhardened material within the cooling element.

12. The process according to claim 10, further comprising, after concluding the production, charging a coolant to the cooling element.

13. An object produced by a process according to claim 10.
